(19) United States
(12) Patent Application Publication
(10) Pub. No.: US 2011/0033238 A1
(43) Pub. Date: Feb. 10, 2011

(54) Greenhouse Gas Reservoir Systems and Processes of Sequestering Greenhouse Gases

(75) Inventor: Walter C. Riese, Katy, TX (US)

Correspondence Address: CAROL WILSON;BP AMERICA INC., MAIL CODE 5 EAST, 4101 WINFIELD ROAD, WARRENVILLE, IL, 60555, US

(73) Assignee: BP CORPORATION NORTH AMERICA INC., Warrenville, IL (US)

(21) Appl. No.: 12/536,560

(22) Filed: Aug. 6, 2009

(51) Int. Cl. E21F 17/16; B65G 5/00

(52) U.S. Cl. 405/53

(57) ABSTRACT

This invention relates to greenhouse gas reservoir systems and processes of storing and/or sequestering greenhouse gases. The greenhouse gas reservoir system includes a shale layer for containment of greenhouse gas and the shale layer has a vertical permeability of less than about 0.1 millidarcies. The greenhouse gas reservoir system includes a sandstone layer disposed at least partially below the shale layer and the sandstone layer delivers the greenhouse gas into the shale layer. The system includes a borehole for injection of the greenhouse gas into the sandstone layer.

### BACKGROUND

1. Technical Field

This invention relates to greenhouse gas reservoir systems and processes of storing or sequestering greenhouse gases.

2. Discussion of Related Art

Issues of greenhouse gas levels and climate change have led to development of technologies seeking to reduce and/or eliminate carbon emissions to the atmosphere. Underground storage of carbon dioxide has been proposed as a potential solution to global warming. Current industry teachings and regulatory direction seek to inject carbon dioxide into saline aquifers underneath what are believed to be impermeable caprocks. However, even with the above technology in carbon emissions, there remains a need and a desire for additional geologic formations for long term storage of greenhouse gases.

### SUMMARY

This invention relates to greenhouse gas reservoir systems and processes of storing and/or sequestering greenhouse gases. The invention includes storage and/or sequestration of greenhouse gases in additional geologic formations, such as shale and shale-like materials. Long term storage of the greenhouse gases can reduce and/or eliminate carbon emissions to the atmosphere.

According to a first embodiment, the invention includes a greenhouse gas reservoir system for storing and/or sequestering greenhouses gases. The system includes a shale layer for containment of greenhouse gas and the shale layer has a vertical permeability of less than about 0.1 millidarcies. The system includes a sandstone layer disposed at least partially below the shale layer and the sandstone layer delivers the greenhouse gas into the shale layer. The system includes a borehole for injection of the greenhouse gas into the sandstone layer.

According to a second embodiment, the invention includes a process of storing and/or sequestering greenhouse gases. The process includes the step of injecting a greenhouse gas down a borehole and into a sandstone layer. The process includes the step of migrating the greenhouse gas into a shale layer for containment and the shale layer has a vertical permeability of less than about 0.1 millidarcies.

According to a third embodiment, the invention includes a greenhouse gas reservoir system for storing and/or sequestering greenhouses gases. The system includes a shale layer for containment of greenhouse gas and a borehole for injection of the greenhouse gas into the shale layer.

According to a fourth embodiment, the invention includes a process of storing and/or sequestering greenhouse gases. The process includes the step of drilling a borehole into a shale layer, and the step of injecting a greenhouse gas down the borehole and into the shale layer.

### BRIEF DESCRIPTION OF THE DRAWING

The accompanying drawings, which are incorporated in and constitute a part of this specification, illustrate embodiments of the invention and, together with the description, serve to explain the features, advantages, and principles of the invention. In the drawings,

FIG. 1 schematically shows a greenhouse gas reservoir system, according to one embodiment; and

FIG. 2 schematically shows a greenhouse gas reservoir system, according to one embodiment.

### DETAILED DESCRIPTION

This invention relates to greenhouse gas reservoir systems and processes of storing and/or sequestering greenhouse gases.

According to one embodiment, the invention can include a method for delivery of carbon dioxide to a shale or other “caprock” for long term storage and/or sequestration from the atmosphere. The storage utilizes and takes advantage of permeability and transmissivity of an underlying formation, commonly referred to as a saline formation and/or a saline aquifer. The method can also take advantage of buoyancy and diffusion attributes of dense phase carbon dioxide and/or super critical carbon dioxide in the underlying formation to deliver carbon dioxide to shale and/or shale like material. Persons of skill in the art typically view shale formations as a “caprock” and/or a “seal” with respect to carbon dioxide.

One possible geologic formation for storage of greenhouse gases can include a shale-saline formation couplet, such as forms a seal-reservoir couplet. The seal and/or the caprock can preclude and/or resist vertical migration of an injected carbon dioxide plume from the underlying reservoir, such as due to physical and/or chemical attributes and/or characteristics of the seal. Migration of carbon dioxide into shallower formations used for drinking water (underground sources of drinking water or USDWs) can change a pH of the aquifer and/or cause loss of containment of the carbon dioxide. Representing the seal-reservoir couplet in this manner seeks containment of the carbon dioxide in the reservoir by the seal, such as milk held in a bottle by glass and a cap.

According to one embodiment, shales and/or shale like materials can be less of seals and provide a primarily depository and/or reservoir for greenhouse gases. Shales and/or shale like materials can be stimulated mechanically and/or with complex drilling techniques. Transmissivity of shales can be used to store and/or transport greenhouse gases, such as where significant quantities of injected carbon dioxide eventually come to rest in the shale and/or the shale like materials. Fracture stimulation of tight (impermeable) formations can achieve gas flow, such as by establishing wellbore pressures which exceed a mechanical (frac) strength of the rock to open a usually vertical crack and/or a complex of cracks in the formation. The crack and/or the complex of cracks can be kept open by pumping in sand or some similar material, such as to act as a proppant after the artificially induced pressure is reduced. The proppant layer of sand (frac-pac) then can become an avenue and/or path for injection of greenhouse gases into the formation.

According to one embodiment, the invention includes the use of saline formations, such as clastics and/or the like, as analogues to the sand in frac-pacs described above. Injection of greenhouse gases into a saline formation represents injection into a delivery system which can deliver substantive volumes of carbon dioxide to and/or into the overlying shale and/or the shale like material. A resulting system can have substantial storage of the greenhouse gas in the shale and/or the shale like material.

This invention can include: 1) a use of a saline formation as a delivery pathway to a shale and/or a shale like material for a greenhouse gas; and 2) the shale and/or the shale like material in a sandstone-shale couplet forms a primary long-term repository for the greenhouse gas (carbon dioxide), such as the shale and/or the shale like material is not a simple passive container seal.

According to one embodiment, this invention includes drilling technologies and/or completion technologies to deliver carbon dioxide into a shale formation and/or a shale like material. Suitable drilling technologies may include horizontal wells, multi-laterals, fracture stimulation, increased formation-wellbore linkage, fracs with additional surface area, and/or the like, so carbon dioxide from the wellbore can access the formation.

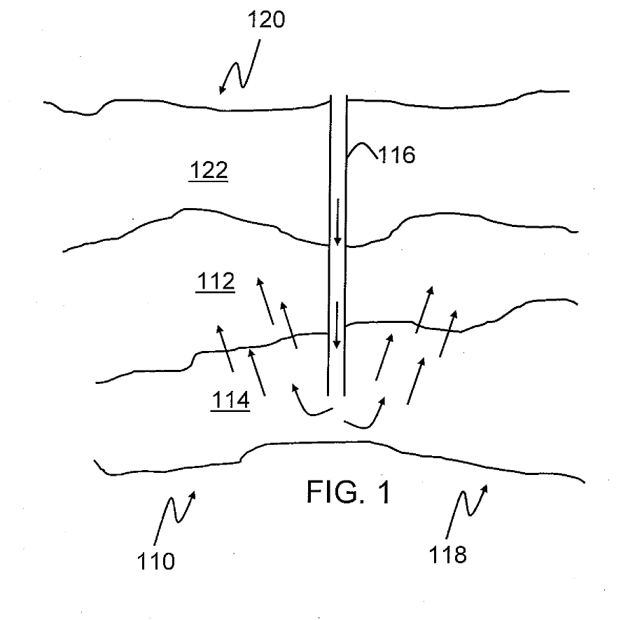

FIG. 1 schematically shows a greenhouse gas reservoir system 110, according to one embodiment. The greenhouse gas reservoir system 110 includes a shale layer 112 with a sandstone layer 114 disposed below the shale layer 112. The greenhouse gas reservoir system 110 includes a borehole 116 through the shale layer 112 and into the sandstone layer 114 for injecting and/or delivering a greenhouse gas into the sandstone layer 114 and ultimately into the shale layer 112, as shown by the arrows. The greenhouse gas migrates and/or moves from the sandstone layer 114 into the shale layer 112, such as by use of pressure, concentration, and/or the like. The sandstone layer 114 may be a saline aquifer 118. The shale layer 112 may be below a surface 120 and may have one or more intervening layers 122 between the surface 120 and the shale layer 112.

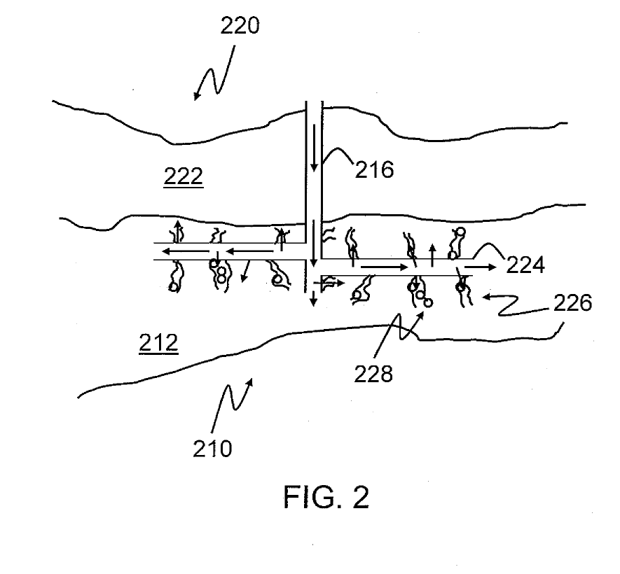

FIG. 2 schematically shows a greenhouse gas reservoir system 210, according to one embodiment. The greenhouse gas reservoir system 210 includes a shale layer 212 and a borehole 216 into the shale layer 212 for injecting and/or delivering a greenhouse gas into the shale layer 212, as shown by the arrows. The shale layer 212 may be below a surface 220 and may have one or more intervening layers 222 between the surface 220 and the shale layer 212. The greenhouse gas reservoir system 210 can include horizontal borings 224, such as to form a stimulated zone 226. The stimulated zone 226 may have proppant 228 placed and/or located within, such as to maintain a crack, fissure, passage, and/or the like.

According to one embodiment, the invention includes a greenhouse gas reservoir system for storing greenhouses gases. The system can include a shale layer for containment of greenhouse gas and the shale layer can have a vertical permeability of less than about 0.1 millidarcies. The system can include a sandstone layer disposed at least partially below the shale layer. The sandstone layer can deliver the greenhouse gas into the shale layer. The system can include a borehole for injection of the greenhouse gas into the sandstone layer.

Gas broadly refers to not being primarily in a solid state and/or a liquid state, such as having a generally indefinite volume (compressible) and/or a generally indefinite shape (fills its container).

Greenhouse gases broadly refer to gases and/or vapors in an atmosphere that can absorb and/or emit radiation within the thermal infrared range, such as carbon monoxide, carbon dioxide, water vapor, methane, ethane, propane, ozone, hydrogen sulfide, sulfur oxides, nitrogen oxides, halocarbons, chlorofluorocarbons (CFCs), and/or the like. Electrical power plants, petroleum refineries, and/or other energy conversion facilities can tend to be large sources of greenhouses gases emitted to the atmosphere.

Without being bound by theory, greenhouse gases are believed to receive and/or retain solar radiation and/or energy which becomes trapped in the atmosphere and causes an increase in average global atmospheric temperatures and/or climate change. According to one embodiment, the greenhouse gas includes primarily, mostly, and/or substantially carbon dioxide, such as at least about 50 percent, at least about 80 percent, at least about 90 percent, at least about 95 percent, and/or the like on a molar basis. The greenhouse gas can be at any suitable temperature and/or pressure.

Reservoir broadly refers to a place and/or a location where something can be kept and/or held, such as in store and/or in an accumulated state.

System broadly refers to a related group and/or a collection of items and/or objects, such as for a unified goal and/or a common purpose.

Storing broadly refers to placing and/or holding in a location, such as for later use and/or disposal.

Sequestration broadly refers to setting apart, depositing, storing, segregating, and/or the like, such as away from contact or inclusion into an atmosphere or to a surface of the Earth. Atmosphere broadly refers to a gaseous material surrounding a planet, such as the Earth.

Shale broadly refers to a generally fissile rock formed by a consolidation of and/or an applied pressure (compaction) to clay, mud, silt, other minerals, other compounds, other elements, and/or the like. Shale generally includes a finely stratified arrangement and/or a laminated structure of minerals essentially mostly unaltered since deposition and/or formation into a sedimentary rock. Shale may contain organic matter and/or material. According to one embodiment, the shale layer may include a fine grained detrital rock of clay, silt, mud, and/or the like.

Layer broadly refers to a thickness of a material and/or a substance, such as a strata and/or a course.

The shale layer may include any suitable properties and/or characteristics, such as a vertical permeability of between about 100 millidarcies and about 1×10⁻⁶ millidarcies, between about 1 millidarcy and about 1×10⁻⁴ millidarcies, less than about 0.1 millidarcies, less than about 0.01 millidarcies, less than about 0.001 millidarcies, less than about 0.0001 millidarcies, and/or the like.

The shale layer may include any suitable size and/or shape, such as a thickness of between about 1 meter and 100,000 meters, between about 500 meters and about 50,000 meters, greater than about 1,000 meters, and/or the like. The shale layer may include any suitable profile and/or contour, such as generally flat, generally sloped and/or pitched in one or more directions, generally concave up (bowl shaped), generally concave down (dome shaped), and/or the like. According to one embodiment, the shale layer has a profile and/or a contour incapable of containing and/or maintaining a bubble from an underside. The shale layer may include any suitable corresponding surface area, such as between about 10 square kilometers and about 2,000 square kilometers, between about 500 square kilometers and about 1,000 square kilometers, and/or the like. The shale layer may be located at any suitable depth below a surface of land and/or a bottom of a body of water, such as between about 0 meters (surface) and about 20,000 meters, between about 100 meters and about 1,000 meters, and/or the like.

The shale layer can have any suitable ratio of thickness to longest horizontal dimension, such as between about 1:10,000 to about 10,000:1, between about 1:1,000 to about 1,000:1, between about 1:100 to about 100:1, and/or the like. Strata and/or layers of the shale material may include any suitable orientation, such as generally horizontal, generally vertical, generally sloped, and/or the like. Particles forming the shale layer may include any suitable size and/or shape, such as an average particle diameter of between about 0.0001 millimeters and about 0.1 millimeters, less than about 0.01 millimeters, less than about 0.001 millimeters, and/or the like.

Sandstone broadly refers to any suitable sedimentary rock formed mainly of sand-size mineral and/or rock grains. Sandstone may include quartz, feldspar, other minerals, other compounds, other elements, and/or the like.

The sandstone layer may include any suitable properties and/or characteristics, such as a vertical permeability of between about 1 millidarcy and about 1×10⁸ millidarcies, between about 1,000 millidarcies and about 1×10⁶ millidarcies, at least about 10 millidarcies, at least about 100 millidarcies, and/or the like.

The sandstone layer may include any suitable size and/or shape, such as a thickness of between about 1 meter and 100,000 meters, between about 500 meters and about 50,000 meters, greater than about 1,000 meters, and/or the like. The sandstone layer may include any suitable profile and/or contour, such as generally flat, generally sloped and/or pitched in one or more directions, generally concave up (bowl shaped), generally concave down (dome shaped), and/or the like. The sandstone layer may include any suitable corresponding surface area, such as between about 10 square kilometers and about 2,000 square kilometers, between about 500 square kilometers and about 1,000 square kilometers, and/or the like. The sandstone layer may be located at any suitable depth below a surface of land and/or a bottom of a body of water, such as between about 0 meters (surface) and about 20,000 meters, between about 100 meters and about 1,000 meters, and/or the like.

The sandstone layer can have any suitable ratio of thickness to longest horizontal dimension, such as between about 1:10,000 to about 10,000:1, between about 1:1,000 to about 1,000:1, between about 1:100 to about 100:1, and/or the like. Strata and/or layers of the sandstone material may include any suitable orientation, such as generally horizontal, generally vertical, generally sloped, and/or the like. Particles forming the sandstone layer may include any suitable size and/or shape, such as an average particle diameter of between about 0.01 millimeters and about 10 millimeters, more than about 0.05 millimeters, more than about 0.1 millimeters, and/or the like.

The sandstone layer may or may not include water, such as soft water, hard water, fresh water, drinking water, saline water, brackish water, salt water, brine, and/or the like. The sandstone layer may include a saline aquifer, such as with flowing water and/or stagnant water. A pH of the water can be generally acidic (less than about 7), generally neutral (about 7), generally basic (greater than about 7), and/or the like.

According to one embodiment, a ratio of the sandstone layer permeability to the shale layer permeability may be between about 1×10⁶:1 and about 10:1, between about 1×10⁴:1 and about 100:1, and/or the like. A ratio of a volume of the shale layer to a volume of the sandstone layer can have any suitable value, such as between about 1:10,000 to about 10,000:1, between about 1:1,000 to about 1,000:1, between about 1:100 to about 100:1, between about 1:10 and about 10:1, and/or the like. Optionally and/or alternatively, the average particle diameter in the sandstone layer can differ from the average particle diameter in the shale layer by a factor of at least 10, at least 100, at least 1,000, and/or the like.

The shale layer and the sandstone layer may be at least generally adjacent and/or contiguous to each other. In the alternative, the shale layer and the sandstone layer may be at least partially isolated and/or separated from each other. Embodiments with one or more intervening layers between the shale layer and the sandstone layer are within the scope of this invention. Similarly, embodiments with more than one shale layer and more than one sandstone layer are within the scope of this invention, such as a shale layer over a sandstone layer over a shale layer over a sandstone layer.

Dispose broadly refers to arrange something in a spot and/or a position, such as with respect to another member, element, and/or thing.

Below broadly refers to being in and/or having a lower position, such as beneath, under, underneath, and/or the like.

Deliver broadly refers to convey, send, bring, and/or the like. Delivery of the greenhouse gas can be at any suitable conditions. The greenhouse gas can be delivered at any suitable temperature, such as between about −100 degrees Celsius and about 500 degrees Celsius, between about −25 degrees Celsius and about 150 degrees Celsius, between about 0 degrees Celsius and about 25 degrees Celsius, and/or the like. The greenhouse gas can be delivered at any suitable pressure, such as between about atmospheric pressure and about 10,000 bars, between about 10 bars and about 1,000 bars, between about 15 bars and about 150 bars, between about 20 bars and about 100 bars, and/or the like on an absolute basis.

The greenhouse gas can be delivered in any suitable state and/or phase, such as a gas, a liquid, a supercritical fluid, a dense phase fluid, a solid, and/or the like. Without being bound by theory, delivery of the greenhouse gas as a supercritical fluid can make for ready transmission into the shale layer, such as due to solvent properties of the supercritical fluid.

Borehole broadly refers to any suitable hole and/or aperture bored and/or drilled in a surface and/or the Earth, such as a narrow shaft drilled in the ground. Boreholes may include vertical segments, deviated segments, horizontal segments, and/or the like. Boreholes and/or engineered boreholes may also include a mud filter cake, a casing, a cement structure, a drillstring, a drill bit, and/or the like. Boreholes may have any suitable length, such as at least about 100 meters, at least about 500 meters, at least about 1,000 meters, at least about 5,000 meters, and/or the like. Boreholes may include any suitable diameter and/or effective diameter, such as at least about 10 centimeters, at least about 25 centimeters, at least about 50 centimeters, at least about 100 centimeters, at least about 500 centimeters, and/or the like.

The diameter of the borehole may vary with length, such as starting at one diameter on a surface and reducing to a smaller diameter further below the surface in a generally stepwise manner. The diameter of the borehole may also include an area of expanded diameter to include a cement barrier thickness, for example. The diameter of the borehole may also depend on types of geologic formations, casing designs, and/or the like. In the alternative, the diameter may increase at depth by underreaming and/or the like. Increasing the diameter may provide extra thickness of cement and/or reduce hoop stresses in the formation, for example.

Desirably, but not necessarily, the borehole includes pipe and/or cement casing through at least a portion of the shale layer and/or at least a portion of the sandstone layer.

Injection broadly refers to forcing and/or flowing a fluid and/or a substance, such as by pumping, compressing, and/or the like.

According to one embodiment, the system can include at least a portion of greenhouse gas contained and/or trapped within at least a portion of the shale layer. Any suitable amount of the greenhouse gas injected down and/or through the borehole can be delivered and/or migrated into the shale layer, such as at least about 1 percent, at least about 10 percent, at least about 30 percent, at least about 50 percent, at least about 70 percent, at least about 90 percent, and/or the like.

A total amount of greenhouse gas placed in the system can be any suitable amount, such as between about 10 metric tons and about 1×10⁹ metric tons, at least about 1,000 metric tons, and/or the like.

The delivery and/or migration of the greenhouse gas into the shale layer can include any suitable time duration to occur, such as between about 1 day and about 10,000 years, between about 1 year and about 1,000 years, between about 2 years and about 500 years, and/or the like.

The greenhouse gas can be contained, held, stored, sequestered, and/or captured within the shale layer in any suitable state and/or form, such as a hydrated state, a clathrate state, a mineralized state, a carbonate state, a residual trapped state, a vapor state, a liquid state, a supercritical fluid state, a dense phase state, a solution state, and/or the like. The hydrated state may include one or more molecules of water to each molecule of the greenhouse gas, such as with hydrogen bonding and/or other weak molecular forces. The mineralized state may include any suitable alkali metals, alkali earth metals, and/or the like. Suitable mineralized compounds may include sodium carbonate, sodium bicarbonate, potassium carbonate, potassium bicarbonate, magnesium carbonate, calcium carbonate, and/or the like.

According to one embodiment, the invention can include a process of storing and/or sequestering greenhouse gases. The process can include the step of injecting a greenhouse gas down a borehole and into a sandstone layer, and the step of migrating the greenhouse gas into a shale layer for containment. The shale layer can have a vertical permeability of less than about 0.1 millidarcies.

The features and/or characteristics of the process can include any of the features and/or characteristics described herein with respect to systems, other processes, and/or the like.

Migrating broadly refers to moving from one place to another and/or changing position, such as from one substance to another.

According to one embodiment, the process further includes the step of reacting the greenhouse gas in the shale layer to form a stable compound. Stable compound broadly refers to being at least somewhat inert with respect to a surrounding environment, such as in a hydrated state, a mineralized state, and/or the like. A suitable mineralized state may include calcium carbonate, magnesium carbonate, and/or the like. Optionally and/or alternatively, the greenhouse gas can reside in a solution, as a bubble, or as a residual trapping within the shale layer.

According to one embodiment, the method may also include the step of displacing and/or liberating a quantity of methane (natural gas), other hydrocarbons, and/or the like. Without being bound by theory, the greenhouse gas can form a preferentially stronger bond than displaced molecules. In the alternative, the method may exclude displacing and/or liberating a quantity of methane.

The migrating may include any suitable flow mechanism and/or regime, such as percolation, diffusion, continuous-phase flow, bulk-phase flow, multi-phase flow, and/or the like. Percolation broadly refers to movement, flow, and/or filtering of fluids through porous materials. Diffusion broadly refers to particles of liquids, gases, and/or solids intermingling as the result of spontaneous motion and/or molecular movements, such as caused by thermal agitation, concentration gradients, Brownian motion, and/or the like.

According to one embodiment, the invention includes a greenhouse gas reservoir system for storing and/or sequestering greenhouses gases. The system can include a shale layer for containment of greenhouse gas, and a borehole for injection of the greenhouse gas into the shale layer.

Desirably, but not necessarily, the borehole can include one or more horizontal borings within the shale layer, such as formed with directional drilling. Optionally and/or additionally, the borehole can include one for more artificially stimulated zones with increased permeability. The artificially stimulated zones can be located in and/or on the one or more horizontal borings, a vertical portion of the borehole, and/or the like. The area of increased permeability can be increased by any suitable factor and/or amount over a surrounding rock formation (without stimulation), such as by a factor of at least about 10, at least about 100, at least about 1,000, at least about 10,000, and/or the like on a molar basis, a volumetric basis, a mass basis, and/or the like.

According to one embodiment, the system can include a proppant placed within at least a portion of the one or more artificially stimulated zones. Proppant broadly refers to any suitable substance and/or material to hold fractures open after a fracturing treatment, such as naturally occurring sand grains, man-made materials, resin-coated sand, high strength ceramic materials, and/or the like. The system may also include a greenhouse gas contained at least partially within the shale layer.

According to one embodiment, the shale layer does not reside above a sandstone layer and/or other delivery capable substrate.

According to one embodiment, the invention can include a process of storing and/or sequestering greenhouse gases. The process can include the step of drilling a borehole into a shale layer, and the step of injecting a greenhouse gas down the borehole and into the shale layer.

The process may also include the step of stimulating one or more zones within the borehole to increase permeability. Stimulating broadly refers to actions and/or deeds to excite to activity, growth, and/or greater activity levels, such as flow of the greenhouse gas. Stimulating can be by any suitable mechanical principles, chemical principles, thermodynamic principles, material science principles, geologic principles, and/or the like. Zone broadly refers to a region and/or an area set off as distinct from a surrounding and/or adjoining part.

According to one embodiment, the process may also include the step of placing a proppant within the one or more zones with increased permeability, such as to keep the zone available for increased flow.

The borehole of the process may include any of the features and/or characteristics discussed above, such as one or more horizontal borings within the shale layer.

As described herein, the invention can include reservoir systems with shale layers and/or sandstone layers, but a person of skill in the art readily appreciates that the reservoir systems can include other geologic formations and/or rock layers of other substances without departing from the sprit and the scope of this invention.

As used herein the terms “having”, “comprising”, and “including” are open and inclusive expressions. Alternately, the term “consisting” is a closed and exclusive expression. Should any ambiguity exist in construing any term in the claims or the specification, the intent of the drafter is toward open and inclusive expressions.

Regarding an order, number, sequence, and/or limit of repetition for steps in a method or process, the drafter intends no implied order, number, sequence and/or limit of repetition for the steps to the scope of the invention, unless explicitly provided.

Regarding ranges, ranges are to be construed as including all points between upper values and lower values, such as to provide support for all possible ranges contained between the upper values and the lower values including ranges with no upper bound and/or lower bound.

It will be apparent to those skilled in the art that various modifications and variations can be made in the disclosed structures and methods without departing from the scope or spirit of the invention. Particularly, descriptions of any one embodiment can be freely combined with descriptions of other embodiments to result in combinations and/or variations of two or more elements and/or limitations. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

What is claimed is:

1. A greenhouse gas reservoir system for storing greenhouses gases, the system comprising:
a shale layer for containment of greenhouse gas and the shale layer having a vertical permeability of less than about 0.1 millidarcies;
a sandstone layer disposed at least partially below the shale layer and the sandstone layer for delivery of the greenhouse gas into the shale layer; and
a borehole for injection of the greenhouse gas into the sandstone layer.

2. The system of claim 1, further comprising a greenhouse gas contained within the shale layer.

3. The system of claim 2, wherein the greenhouse gas comprises primarily carbon dioxide.

4. The system of claim 2, wherein the shale layer contains at least a portion of the greenhouse gas in a hydrated state, a mineralized state, a residual trapped state, or a solution state.

5. The system of claim 1, wherein the shale layer comprises a fine grained detrital rock of clay, silt, or mud.

6. The system of claim 1, wherein the sandstone layer comprises a saline aquifer.

7. A process of storing or sequestering greenhouse gases, the process comprising:
injecting a greenhouse gas down a borehole and into a sandstone layer; and
migrating the greenhouse gas into a shale layer for containment, the shale layer having a vertical permeability of less than about 0.1 millidarcies.

8. The process of claim 71 further comprising reacting the greenhouse gas in the shale layer to form a stable compound.

9. The process of claim 8, wherein the stable compound comprises a hydrated state or a mineralized state.

10. The process of claim 9, wherein the mineralized state comprises a calcium carbonate or magnesium carbonate.

11. The process of claim 7, wherein the greenhouse gas resides in a solution or a residual trapping within the shale layer.

12. The process of claim 7, wherein the greenhouse gas comprises primarily carbon dioxide.

13. The process of claim 7, wherein the migrating comprises percolation, diffusion, or continuous-phase flow.

14. A greenhouse gas reservoir system for storing greenhouses gases, the system comprising:
a shale layer for containment of greenhouse gas; and
a borehole for injection of the greenhouse gas into the shale layer.

15. The system of claim 14, wherein the borehole comprises one or more horizontal borings within the shale layer.

16. The system of claim 15, further comprising one for more artificially stimulated zones with increased permeability, the artificially stimulated zones located in or on the one or more horizontal borings or a vertical portion of the borehole.

17. The system of claim 16, further comprising a proppant placed within at least a portion of the one or more artificially stimulated zones.

18. The system of claim 14, further comprising a greenhouse gas contained within the shale layer.

19. A process of storing or sequestering greenhouse gases, the process comprising:
drilling a borehole into a shale layer; and
injecting a greenhouse gas down the borehole and into the shale layer.

20. The process of claim 19, further comprising stimulating one or more zones within the borehole to increase permeability.

21. The process of claim 19, further comprising placing a proppant within the one or more zones with increased permeability.

22. The process of claim 19, wherein the borehole comprises one or more horizontal borings within the shale layer.
